(19) United States
(12) Patent Application Publication
(10) Pub. No.: US 2025/0189729 A1
(43) Pub. Date: Jun. 12, 2025

(54) Fiber Optic Adapter

(71) Applicant: Legrand DPC, LLC, West Hartford, CT (US)

(72) Inventors: Guy Randall Bridges, Shelby, NC (US); Chen Chou-Hsin, Keelung City (TW); Daniel M. Smith, Westerly, RI (US)

(73) Assignee: Legrand DPC, LLC, West Hartford, CT (US)

(21) Appl. No.: 18/530,520

(22) Filed: Dec. 6, 2023

(51) Int. Cl. G02B 6/38

(52) U.S. Cl. CPC G02B 6/3825; G02B 6/3874

(57) ABSTRACT

An example fiber optic adapter is provided. The fiber optic adapter includes a housing including a hollow interior, and an interior barrier wall disposed within the hollow interior. The fiber optic adapter includes an insert including a wall. At least one of the housing or the insert includes rivet extensions protruding from the interior barrier wall or the wall, respectively. At least one of the housing or the insert includes rivet alignment openings formed in the interior barrier wall or the wall, respectively. The housing is configured to receive the insert in the hollow interior such that the rivet alignment openings at least partially receive the rivet extensions, and the wall of the insert abuts the interior barrier wall of the housing.

### BACKGROUND

Media patching systems of the telecommunications industry are capable of receiving optical fibers in a variety of manners. In some instances, fiber optic adapters are used to receive fiber connectors (e.g., LC connectors, or the like), and media patching panels are configured to receive such fiber optic adapters for easier, grouped installation and/or removal. Traditional fiber optic adapters are generally assembled by ultrasonically welding together two adapter housing halves, with the adapter housing halves retaining a set of ceramic optical alignment sleeves held captive between them. The ultrasonic welding joint, if performed improperly, can create a point of weakness which, if subjected to sufficient shear or bending stresses, can break. This would result in failure of the fiber optic adapter.

When fiber optic adapters are used with larger or longer fiber connectors which provide additional leverage, the risk of damage during shipment and handling of the fiber optic adapters increases. In addition, the process of ultrasonic welding is extremely process-sensitive, requiring careful control of temperature, humidity, and machine parameters. Further, the process often requires adjustment based on resin color, as colorants alter the mechanical and thermal properties of the plastic being welded. Traditional media applications further require a wide range of adapter colors to be used to signify various network attributes (e.g., fiber type, polish angle, or the like). This requires the process results of ultrasonic welding to be monitored by constant verification testing to ensure detection of manufacturing defects. Some traditional fiber optic adapters include components that assemble via a snap fit. In such instances, the manufacturing process of the separate components can be complex and assembly complications can occur due to misalignment or improper latching. As a result, traditional fiber optic adapters can have points of structural weakness and necessitate careful assembly/manufacturing to reduce chances of mechanical failure.

### SUMMARY

Embodiments of the present disclosure provide a fiber optic adapter including a one-piece housing and a sleeve-retaining insert. The housing and insert are molded in a manner that allows for mechanical riveting of the components, thereby avoiding the traditional process of ultrasonic welding or snap-fit of components. The housing and insert can be fabricated using injection molded plastic (e.g., polyetherimide, or the like). The assembly includes extensions or rivets on both the housing and the insert to ensure proper alignment of the components before riveting, significantly reducing the complexity of the assembly process. The one-piece housing also provides a single, continuous, solid exterior which reduces the susceptibility for failure when the housing is subjected to shear and/or bending stresses.

During assembly, the insert can include three extensions/rivets and the housing can include six extensions/rivets, with the housing and insert having complementary openings to receive the respective extensions/rivets. Additional openings in the housing and insert include radial steps that receive and act as stops for alignment sleeves, thereby retaining the alignment sleeves on opposing sides during assembly of the housing and insert. Once the extensions/rivets are inserted into the corresponding openings, a mechanical press can be used to deform and radially expand the rivet ends or details to permanently fasten the housing and insert together, retaining the alignment sleeves between the housing and insert. The assembly of the fiber optic adapter is therefore simplified with improved assistance in alignment, resulting in a stronger assembly that maintains the alignment sleeves captive in the desired position. The assembly process provides an improvement in strength, cost and consistency relative to traditional assembly processes.

In accordance with embodiments of the present disclosure, an exemplary fiber optic adapter is provided. The fiber optic adapter includes a housing including a hollow interior, and an interior barrier wall disposed within the hollow interior. The fiber optic adapter includes an insert including a wall. At least one of the housing or the insert includes rivet extensions protruding from the interior barrier wall or the wall, respectively. At least one of the housing or the insert includes rivet alignment openings formed in the interior barrier wall or the wall, respectively. The housing is configured to receive the insert in the hollow interior such that the rivet alignment openings at least partially receive the rivet extensions, and the wall of the insert abuts the interior barrier wall of the housing.

In some embodiments, the housing can define a one-piece structure. The fiber optic adapter includes fiber alignment sleeves disposed between the housing and the insert. The fiber alignment sleeves pass at least partially through the interior barrier wall of the housing and the wall of the insert. In some embodiments, the housing includes the rivet extensions protruding from a first side of the interior barrier wall, and the insert includes the rivet alignment openings formed in the wall.

The housing includes sleeve retaining extensions protruding from one side of the interior barrier wall. Each of the sleeve retaining extensions includes an opening extending therethrough and including an inner radial step. The inner radial step defines a change in diameter of the opening of the sleeve retaining extensions, and acts as a stop for engaging with a fiber alignment sleeve positioned within the opening.

In some embodiments, the insert includes the rivet extensions protruding from a first side of the wall, and the interior barrier wall of the housing includes the rivet alignment openings. The insert includes sleeve retaining extensions protruding from one side of the wall. Each of the sleeve retaining extensions includes an opening extending therethrough and including an inner radial step. The inner radial step defines a change in diameter of the opening of the sleeve retaining extensions, and acts as a stop for engaging with a fiber alignment sleeve positioned within the opening.

In some embodiments, both the interior barrier wall of the housing and the wall of the insert include the rivet extensions and the rivet alignment openings. Both the interior barrier wall of the housing and the wall of the insert include sleeve retaining extensions, each of the sleeve retaining extensions including an opening extending therethrough and including an inner radial step. During assembly, the sleeve retaining extensions of the housing receive a first end of fiber alignment sleeves and the sleeve retaining extensions of the insert receive a second end of the fiber alignment sleeves, with the housing and the insert retaining the fiber alignment sleeves therebetween. The inner radial steps of the sleeve retaining extensions prevent removal of the fiber alignment sleeves out of the sleeve retaining extensions. In some embodiments, the rivet extensions and the rivet alignment openings are disposed around or between the sleeve retaining extensions to provide clearance for connection to the sleeve retaining extensions. The rivet extensions are configured to be at least partially deformed to permanently secure the insert to the housing.

In accordance with embodiments of the present disclosure, an exemplary method of fiber optic adapter assembly is provided. The method includes passing an insert into a hollow interior of a housing. The housing includes an interior barrier wall disposed within the hollow interior, and the insert includes a wall. At least one of the housing or the insert includes rivet extensions protruding from the interior wall or the wall, respectively. At least one of the housing or the insert includes rivet alignment openings formed in the interior barrier wall or the wall, respectively. The method includes sliding the insert within the hollow interior of the housing such that the rivet alignment openings at least partially receive the rivet extensions. The method includes positioning the wall of the insert against the interior barrier wall of the housing.

Both the interior barrier wall of the housing and the wall of the insert include sleeve retaining extensions each including an opening extending therethrough and including an inner radial step. The method includes inserting a first end of fiber alignment sleeves into the sleeve retaining extensions of the housing before passage of the insert into the hollow interior of the housing. The method includes inserting a second end of the fiber alignment sleeves into the sleeve retaining extensions of the insert during sliding of the insert within the hollow interior of the housing, to retain the fiber alignment sleeves between the housing and the insert. The method includes deforming ends of the rivet extensions to permanently couple the housing and the insert.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the fiber optic adapter, reference is made to the accompanying figures, wherein:

FIG. 1 is a front perspective view of an exemplary fiber optic adapter in accordance with embodiments of the present disclosure.

FIG. 2 is a rear perspective view of an exemplary fiber optic adapter of FIG. 1.

FIG. 3 is a cross-sectional view of an exemplary fiber optic adapter of FIG. 1.

FIG. 4 is a front perspective view of a housing of an exemplary fiber optic adapter of FIG. 1.

FIG. 5 is a rear perspective view of a housing of an exemplary fiber optic adapter of FIG. 1.

FIG. 6 is a front view of a housing of an exemplary fiber optic adapter of FIG. 1.

FIG. 7 is a rear view of a housing of an exemplary fiber optic adapter of FIG. 1.

FIG. 8 is a front perspective view of an insert of an exemplary fiber optic adapter of FIG. 1.

FIG. 9 is a rear perspective view of an insert of an exemplary fiber optic adapter of FIG. 1.

FIG. 10 is a front view of an insert of an exemplary fiber optic adapter of FIG. 1.

FIG. 11 is a rear view of an insert of an exemplary fiber optic adapter of FIG. 1.

### DETAILED DESCRIPTION

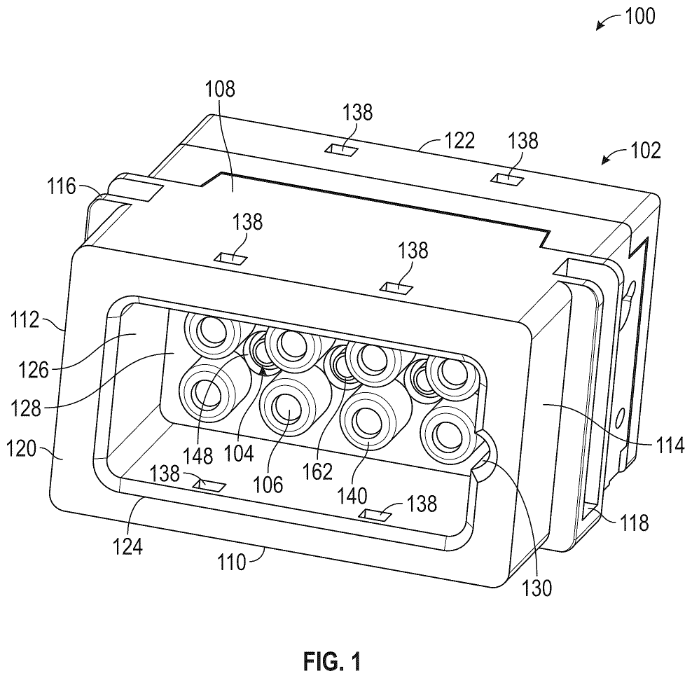

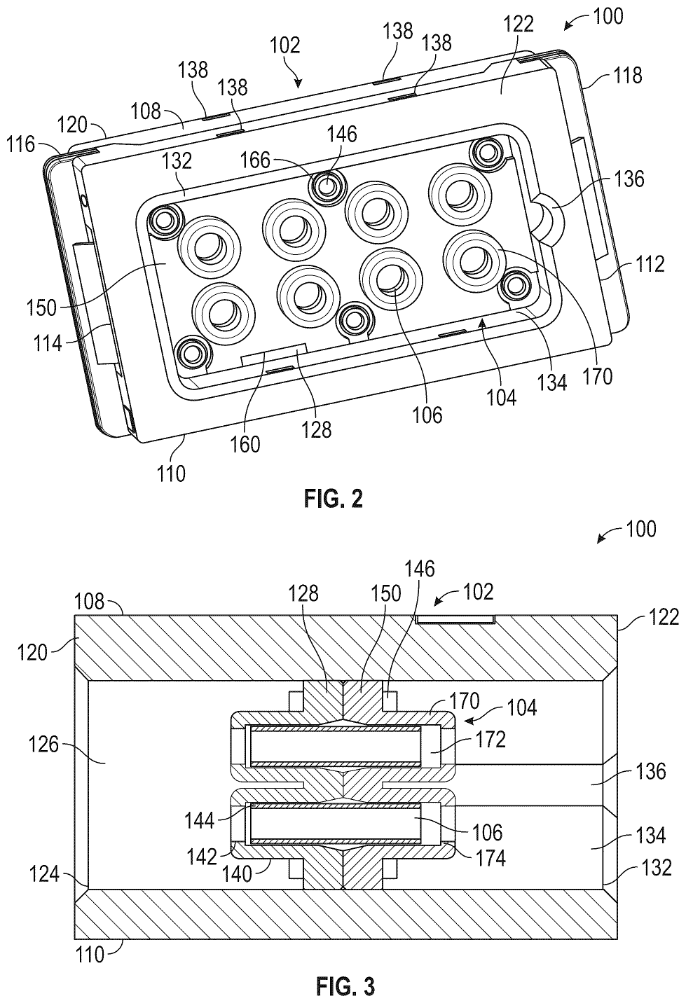

FIGS. 1-3 are front perspective, rear perspective, and cross-sectional views of an exemplary fiber optic adapter 100 (hereinafter “adapter 100”). Although the adapter 100 is configured for implementation as an alignment independent multifiber (AIM) adapter, it should be understood that the adapter 100 can be reconfigured for all other fiber optic connector types which employ captive alignment sleeves. However, even if reconfigured for another fiber optic connector type or combination of fiber optic connector types, the overall assembly and improvements discussed herein with respect to the adapter 100 would still apply.

The adapter 100 includes a one-piece housing 102 that receives and is coupled with a sleeve-retaining insert 104 to encase ferrule alignment sleeves 106. The housing 102 and/or insert can be fabricated using injection molded plastic (e.g., polyetherimide, or the like). The one-piece housing 102 provides a structurally stronger exterior that is capable of withstanding greater shear and/or bending stresses without failure as compared to a traditional adapter housing with two halves of roughly equal size. The housing 102 therefore provides improved protection to the insert 104 and the alignment sleeves 106. In addition, as discussed herein, the housing 102 and the insert 104 are mechanically coupled via rivets, which reduces risk of structural weakness typically encountered in traditional ultrasonic welded components, and provides a visual means of confirming that the assembly process was performed correctly.

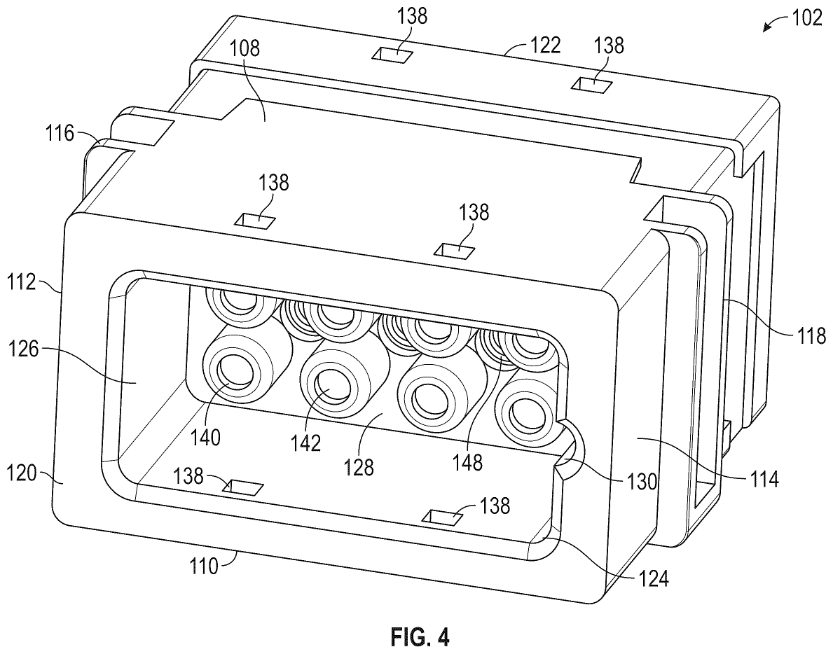

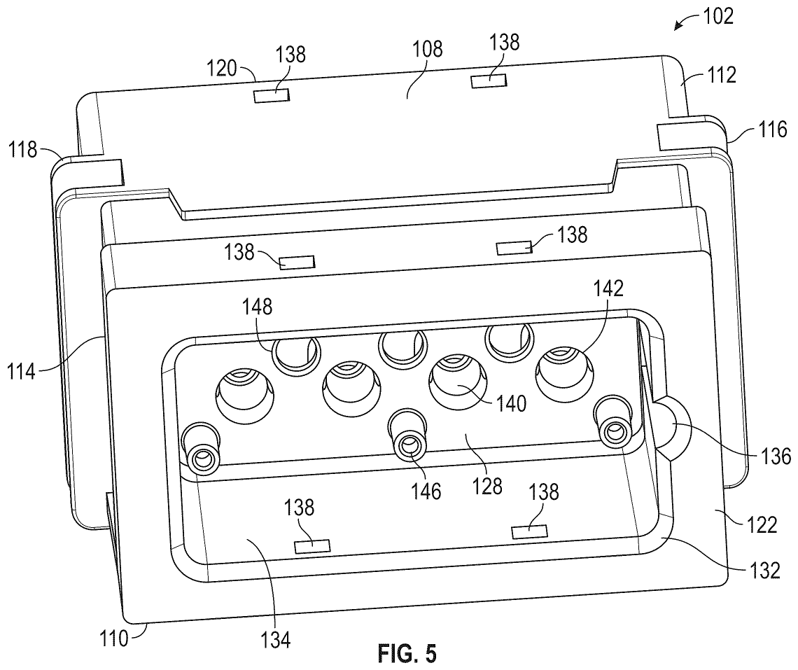

FIGS. 4-7 show front perspective, rear perspective, front and rear views of the housing 102. With reference to FIGS. 1-3 and FIGS. 4-7, the housing 102 includes a body with a top surface 108, an opposing bottom surface 110, and opposing side surfaces 112, 114. The housing 102 can define a substantially rectangular configuration. The top and bottom surfaces 108, 110 extend substantially parallel to each other, and the side surfaces 112, 114 extend substantially parallel to each other. The side surfaces 112, 114 each include flanges 116, 118 extending substantially perpendicularly outward from the housing 102. The flanges 116, 118 include an inner slot configured to detachably receive at least a portion of a metal retainer clip (e.g., a stamped metal retainer clip) typically used for adapter retention in, e.g., a patch panel, or the like.

One end of the housing 102 defines a front face 120 and the opposing end of the housing 102 defines a rear face 122. The front and rear faces 120, 122 can be substantially parallel to each other and define substantially flat surfaces. The front face 120 includes an opening 124 (e.g., a substantially rectangular opening) formed therein and extending into the hollow interior of the housing 102. Inner walls 126 define a substantially rectangular, hollow space within the housing 102 and extend up to an interior barrier wall 128. The interior barrier wall 128 extends substantially perpendicularly relative to the inner walls 126 (and relative to the top surface 108, the bottom surface 110, and side surfaces 112, 114). In some embodiments, the interior barrier wall 128 can be substantially centrally located within the housing 102. The interior barrier wall 128 extends entirely from the top inner surface to the bottom inner surface, and between the inner side surfaces of the inner walls 126. In some embodiments, one of the inner walls 126 (e.g., a side wall) can include a keying groove 130 to assist with alignment of connectors used with the adapter 100.

The rear face 122 includes an opening 132 (e.g., a substantially rectangular opening) formed therein and extending into the hollow interior of the housing 102. The inner walls 134 define a substantially rectangular, hollow space within the housing 102 and extend up to the opposing side of the interior barrier wall 128. Thus, opposing sides of the interior barrier wall 128 face the respective front and rear directions of the housing 102. In some embodiments, one of the inner walls 134 (e.g., a side wall) can include a keying groove 136 to assist with alignment of connectors used with the adapter 100. In some embodiments, the top and/or bottom surfaces 108, 110 of the housing 102 can include holes 138 formed therein for releasably engaging with complementary latching elements of connectors used with the housing 102. In some embodiments, rather than extending entirely through the housing 102 wall, the holes 138 can be formed as grooves at the inner walls 126, 134.

On one side (e.g., the front face) of the interior barrier wall 128, the housing 102 includes sleeve retaining extensions 140 extending substantially perpendicularly from the interior barrier wall 128. In some embodiments, the housing 102 can include eight extensions 140, although it should be understood that any number of extensions 140 could be used. Each extension 140 includes a central opening 142 having an internal radial step 144 that creates a change in diameter. In particular, the diameter of the opening 142 at the front end of the extension 140 is dimensioned smaller than the diameter of the opening 142 at the rear (i.e., interior) end of the extension 140. The internal radial step 144 acts as a stop for receiving and positioning the sleeve 106 within the extensions 140, e.g., the step 144 prevents further insertion of the sleeve 106 into the extension 140. The openings 142 extend through the interior barrier wall 128 to the opposing side, and define the positions for fiber optic ferrules to insert and mate within the adapter 100.

The opposing side (e.g., the rear face) of the interior barrier wall 128 includes rivet extensions 146 extending substantially perpendicularly from the interior barrier wall 128. In some embodiments, the housing 102 can include six extensions 146, although it should be understood that any number of extensions 146 could be used. The ends of the extensions 146 can include central openings partially extending into the extensions 146 to enable consistent deformation during the riveting process.

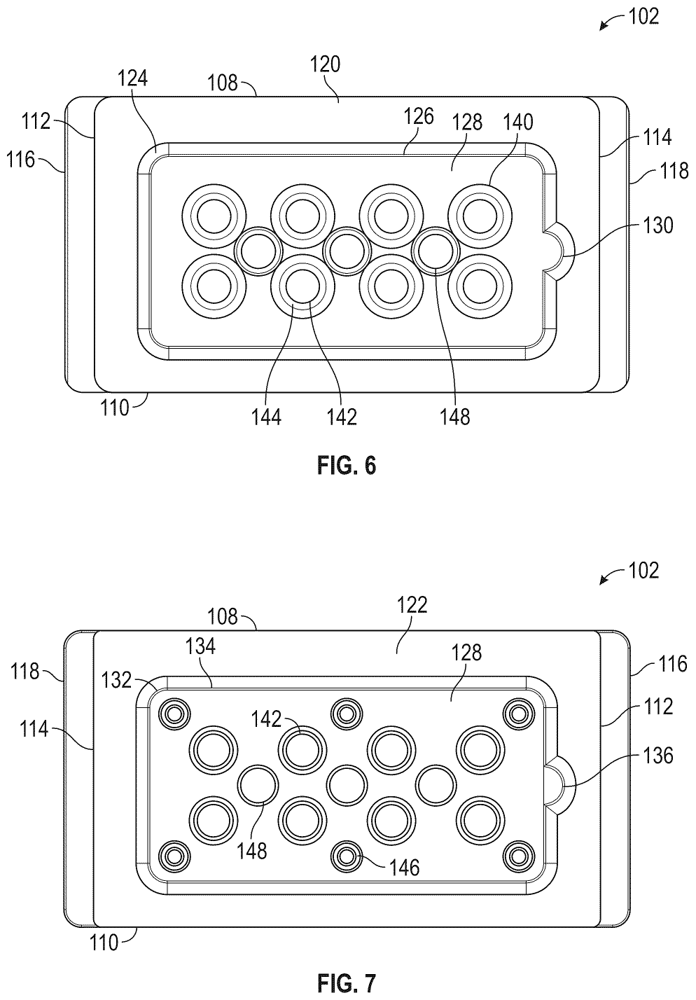

The interior barrier wall 128 includes rivet alignment openings 148 extending through the wall 128. As described herein, the openings 148 are configured to at least partially receive the rivet extensions of the insert 104 to assist with alignment of the insert 104 relative to the housing 102 during assembly. In some embodiments, as illustrated in FIGS. 6-7, the pattern of spaced rivet extensions 146 can be distributed around the pattern of openings 142 of the sleeve retaining extensions 140, and the openings 142 can be distributed around the rivet alignment openings 148. The extensions 146 and openings 142 are distributed in a manner that avoids interference with connectors, e.g., AIM connectors, engaged with the extensions 140.

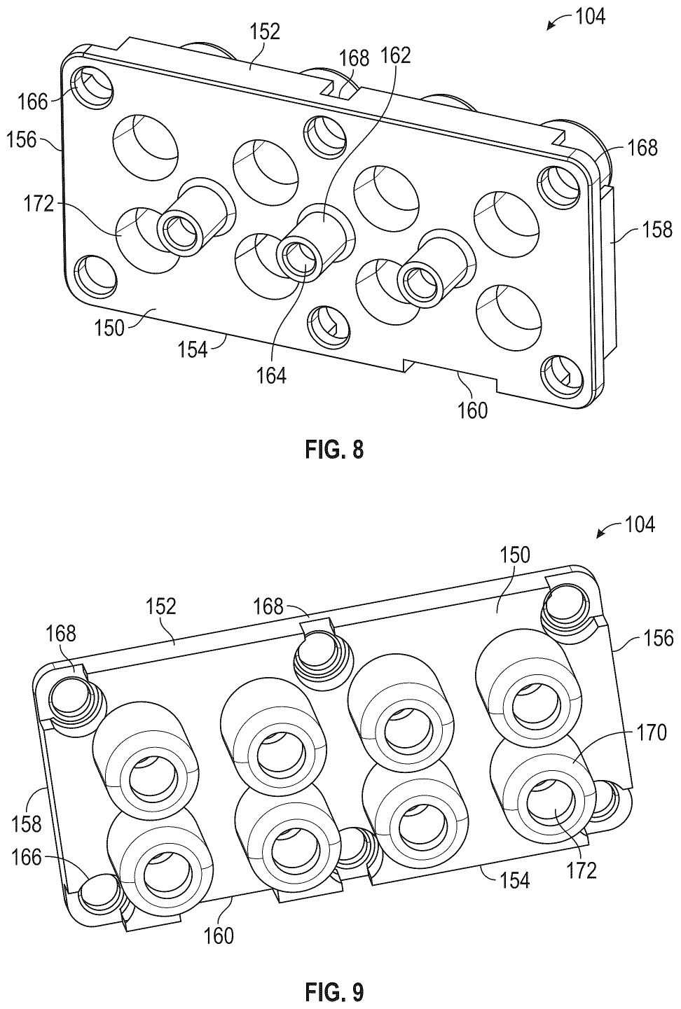

FIGS. 8-11 show front perspective, rear perspective, front and rear views of the insert 104. With reference to FIGS. 1-3 and 8-11, the insert 104 includes a wall 150 that defines a substantially rectangular configuration complementary to the openings 124, 132 formed in the housing 102 such that the insert 104 can be passed into the housing 102 and against the interior barrier wall 128. The wall 150 includes a top surface 152, an opposing bottom surface 154, and opposing side surfaces 156, 158. The top and bottom surfaces 152, 154 extend substantially parallel to each other, and the side surfaces 156, 158 extend substantially parallel to each other. In some embodiments, one of the surfaces (e.g., the bottom surface 154) can include a cutout or slot 160 configured to receive a tool, such as a screwdriver, to assist with prying the insert during assembly or disassembly of the housing 102 and insert 104.

One side (e.g., the front face) of the wall 150 includes rivet extensions 162 extending substantially perpendicularly from the wall 150. In some embodiments, the insert 104 can include three extensions 162 corresponding to three rivet alignment openings 148 in the housing 102, although it should be understood that any number of extensions 162 and openings 148 could be used. The end of the extensions 162 can include central openings 164 partially extending into the extensions 162 to enable consistent deformation during the riveting process.

The wall 150 includes rivet alignment openings 166 extending through the wall 150. The openings 166 are configured to at least partially receive the respective rivet extensions 146 of the housing 102 to assist with alignment of the insert 104 relative to the housing 102 during assembly. The number of openings 166 corresponds with the number of extensions 146 in the housing 102. In some embodiments, the rear face of the wall 150 can include recessed radial grooves 168 around each of the openings 166 to provide clearance for deformed ends of the extensions 146 after the riveting process is complete.

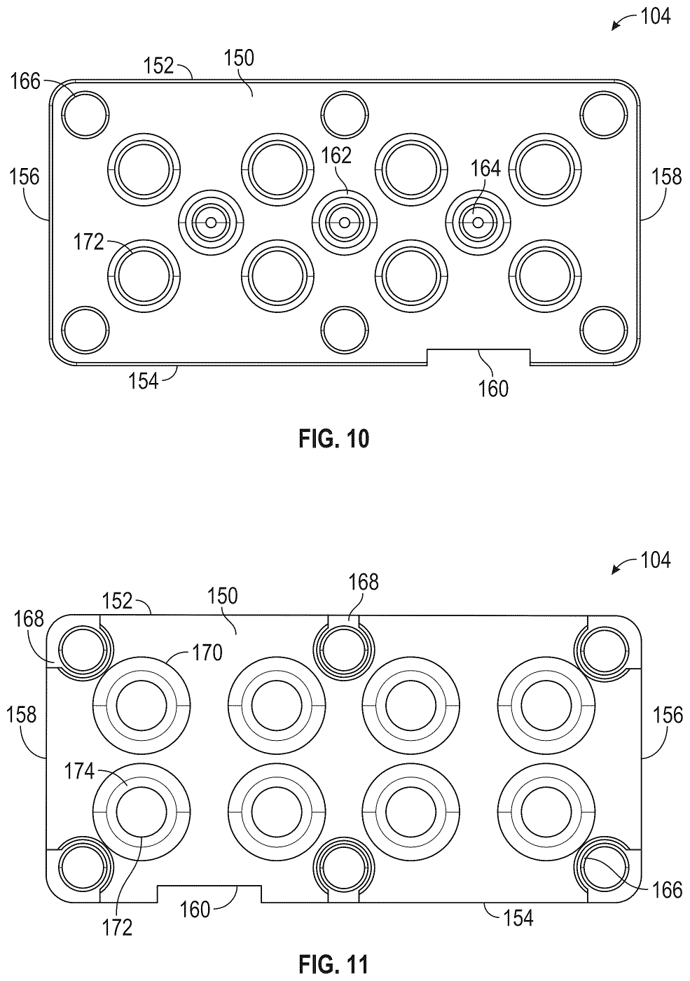

The opposing side (e.g., the rear face) of the wall 150 includes sleeve retaining extensions 170 extending substantially perpendicularly from the wall 150. The number of extensions 170 corresponds with the number of extensions 140 of the housing 102 (e.g., eight extensions). Each extension 170 includes a central opening 172 having an internal radial step 174 that creates a change in diameter. In particular, the diameter of the opening 172 at the rear end of the extension 170 is dimensioned smaller than the diameter of the opening 172 at the front (i.e., interior) end of the extension 170. The internal radial step 174 acts as a stop for receiving and positioning the sleeve 106 within the extensions 170, e.g., the step 174 prevents further insertion of the sleeve 106 into the extension 170. The steps 144, 174 of the extensions 140, 170 capture the sleeve 106 between the housing 102 and the insert 104. The openings 172 extend through the wall 150 to the opposing side, and define the positions for fiber optic ferrules to insert and mate within the adapter 100. In some embodiments, as illustrated in FIGS. 10-11, the pattern of openings 166 can be distributed around the pattern of extensions 170, and the extensions 170 can be distributed around the extensions 162. The openings 166 and the extensions 162 are distributed in a manner that avoids interference with connectors, e.g., AIM connectors, engaged with the extensions 170.

In some embodiments, the insert 104 can be fabricated to have the same color as the housing 102. In some embodiments, the insert 104 can be fabricated to have a different color from housing 102. To meet industrial standards (e.g., TIA-568.3), fiber adapters 100 generally must have externally-visible coloring in order to convey the type of fiber connections to be made therein. However, depending on the colorants used, which vary by color, the overall mechanical strength of the resin can increase or decrease by as much as 15% as compared to the natural, uncolored resin. Black colorant, being primarily carbon black, tends to increase the overall strength by adding cross-linking to the polymer chains. The insert 104, which has fewer rivets than the main housing 102, could be fabricated in a black color to provide greater strength within the adapter 100, while the main housing 102, which is inherently stronger, can bear the burden of color coding by itself (e.g., a non-black color).

As illustrated in FIGS. 1-3, during assembly, the sleeve 106 can initially be positioned in the openings 142 of the retaining extensions 140 of the housing 102 until one end of the sleeve 106 abuts the internal radial step 144. Next, the insert 104 can be inserted through the opening 132 in the housing 102 and slid along the inner walls 134 until the rivet extensions 146 of the housing 102 engage with the rivet alignment openings 166 of the insert 102, and the rivet extensions 162 of the insert 104 engage with the rivet alignment openings 148 of the housing 102. In some embodiments, engagement of these elements of the housing 102 and insert 104 can occur substantially simultaneously and assists with alignment of the insert 104 relative to the housing 102 during assembly. As the insert 104 and the housing 102 engage, the opposing “free” end of the sleeve 106 end is substantially simultaneously inserted into the opening 172 of the retaining extensions 170 of the insert 104. The insert 104 can be slid further inward until the wall 150 of the insert 104 abuts the interior barrier wall 128 of the housing 102. After the insert 104 has been positioned against the interior barrier wall 128 of the housing 102, a mechanical press can be used to deform and radially expand the ends of the rivet extensions 146, 162 to permanently fasten the housing 102 and insert 104 together, and to retain the sleeve 106 between the housing 102 and the insert 104. The radial steps 144, 174 of the housing 102 and insert 104 maintain the sleeve 106 in position within the adapter 100. Assembly of the adapter 100 therefore occurs without ultrasonic welding or snapping of components together.

In some embodiments, the retaining insert 104 can be installed from the rear of the housing 102. This can enable the same insert 104 to be used for both conventional and conversion adapters 100, as both have an AIM interface in the rear. The result is an adapter 100 which has the same overall form factor as existing adapters, but which is much more mechanically resilient, and easier to manufacture, both by manual operation and in an automated setting. The alignment elements (e.g., rivets) of the housing 102 and insert 104 ensure that assembly occurs correctly, thereby simplifying the overall assembly process, reducing chance of error, and ensuring a stronger assembly around the sleeves 106. The assembly process provides an improvement in strength, cost and consistency relative to traditional assembly processes for adapters.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A fiber optic adapter, comprising:
a housing including (i) a hollow interior, and (ii) an interior barrier wall disposed within the hollow interior; and
an insert including a wall;
wherein at least one of the housing or the insert includes rivet extensions protruding from the interior barrier wall or the wall, respectively;
wherein at least one of the housing or the insert includes rivet alignment openings formed in the interior barrier wall or the wall, respectively; and
wherein the housing is configured to receive the insert in the hollow interior such that the rivet alignment openings at least partially receive the rivet extensions, and the wall of the insert abuts the interior barrier wall of the housing.

2. The fiber optic adapter of claim 1, wherein the housing defines a one-piece structure.

3. The fiber optic adapter of claim 1, comprising fiber alignment sleeves disposed between the housing and the insert, wherein the fiber alignment sleeves pass at least partially through the interior barrier wall of the housing and the wall of the insert.

4. The fiber optic adapter of claim 1, wherein the housing includes the rivet extensions protruding from a first side of the interior barrier wall, and the insert includes the rivet alignment openings formed in the wall.

5. The fiber optic adapter of claim 1, wherein the housing comprises sleeve retaining extensions protruding from one side of the interior barrier wall.

6. The fiber optic adapter of claim 5, wherein each of the sleeve retaining extensions includes an opening extending therethrough and including an inner radial step.

7. The fiber optic adapter of claim 6, wherein the inner radial step defines a change in diameter of the opening of the sleeve retaining extensions, and acts as a stop for engaging with a fiber alignment sleeve positioned within the opening.

8. The fiber optic adapter of claim 1, wherein the insert includes the rivet extensions protruding from a first side of the wall, and the interior barrier wall of the housing includes the rivet alignment openings.

9. The fiber optic adapter of claim 1, wherein the insert comprises sleeve retaining extensions protruding from one side of the wall.

10. The fiber optic adapter of claim 9, wherein each of the sleeve retaining extensions includes an opening extending therethrough and including an inner radial step.

11. The fiber optic adapter of claim 10, wherein the inner radial step defines a change in diameter of the opening of the sleeve retaining extensions, and acts as a stop for engaging with a fiber alignment sleeve positioned within the opening.

12. The fiber optic adapter of claim 1, wherein both the interior barrier wall of the housing and the wall of the insert include the rivet extensions and the rivet alignment openings.

13. The fiber optic adapter of claim 1, wherein both the interior barrier wall of the housing and the wall of the insert include sleeve retaining extensions, each of the sleeve retaining extensions including an opening extending therethrough and including an inner radial step.

14. The fiber optic adapter of claim 13, wherein during assembly, the sleeve retaining extensions of the housing receive a first end of fiber alignment sleeves and the sleeve retaining extensions of the insert receive a second end of the fiber alignment sleeves, with the housing and the insert retaining the fiber alignment sleeves therebetween.

15. The fiber optic adapter of claim 14, wherein the inner radial steps of the sleeve retaining extensions prevent removal of the fiber alignment sleeves out of the sleeve retaining extensions.

16. The fiber optic adapter of claim 13, wherein the rivet extensions and the rivet alignment openings are disposed around or between the sleeve retaining extensions to provide clearance for connection to the sleeve retaining extensions.

17. The fiber optic adapter of claim 1, wherein the rivet extensions are configured to be at least partially deformed to permanently secure the insert to the housing.

18. A method of fiber optic adapter assembly, comprising:
passing an insert into a hollow interior of a housing, (i) the housing including an interior barrier wall disposed within the hollow interior, (ii) the insert including a wall, (iii) at least one of the housing or the insert including rivet extensions protruding from the interior wall or the wall, respectively, and (iv) at least one of the housing or the insert including rivet alignment openings formed in the interior barrier wall or the wall, respectively;
sliding the insert within the hollow interior of the housing such that the rivet alignment openings at least partially receive the rivet extensions; and
positioning the wall of the insert against the interior barrier wall of the housing.

19. The method of claim 18, wherein:
both the interior barrier wall of the housing and the wall of the insert include sleeve retaining extensions each including an opening extending therethrough and including an inner radial step; and
wherein the method comprises inserting a first end of fiber alignment sleeves into the sleeve retaining extensions of the housing before passage of the insert into the hollow interior of the housing, and further comprising inserting a second end of the fiber alignment sleeves into the sleeve retaining extensions of the insert during sliding of the insert within the hollow interior of the housing, to retain the fiber alignment sleeves between the housing and the insert.

20. The method of claim 18, comprising deforming ends of the rivet extensions to permanently couple the housing and the insert.
